(19) United States
(12) Patent Application Publication
(10) Pub. No.: US 2025/0112492 A1
(43) Pub. Date: Apr. 3, 2025

(54) ENERGY AUTONOMOUS SENSOR PLATFORM ASSISTED BY A SUPERCAPACITOR

(71) Applicant: STMicroelectronics International N.V., Geneva (CH)

(72) Inventor: Roberto LA ROSA, Viagrande (IT)

(73) Assignee: STMicroelectronics International N.V., Geneva (CH)

(21) Appl. No.: 18/478,553

(22) Filed: Sep. 29, 2023

(51) Int. Cl. H02J 7/34; H02J 7/00

(52) U.S. Cl. CPC H02J 7/345; H02J 7/007182; H02J 7/342; H02J 2207/10; H02J 2207/50

(57) ABSTRACT

Disclosed is an energy autonomous system including an energy transducer, a first capacitor, a second capacitor having greater capacitance than the first capacitor, and a microprocessor. The microprocessor includes a first terminal electrically coupled to the energy transducer and the first capacitor; a second terminal electrically coupled to the second capacitor; a switch that is in a conductive state in which the switch electrically couples the first terminal and second terminals together, or a nonconductive state in which the switch does not electrically couple first terminal and second terminals together; a voltage detector that detects a voltage at the first terminal; and a processor coupled to the voltage detector and the switch. The processor controls charging of the second capacitor by controlling the switch to be in the conductive state or the nonconductive state based on the voltage at the first terminal detected by the voltage detector.

### BACKGROUND

### Technical Field

The present disclosure relates generally to energy autonomous sensor platforms, and more particularly to energy autonomous sensor platforms that are assisted by a supercapacitor to continue functioning while an energy transducer acting as a primary source of energy does not produce energy.

### Description of the Related Art

Conventionally, systems use a power management integrated circuit (PMIC) to charge an energy storage device (e.g., a battery) based on output from an energy transducer (e.g., a photovoltaic cell). Such PMICs consume some of the energy output from the energy transducer, which is not available to store in the energy storage device. Additionally, PMICs increase the cost of materials for such systems.

### BRIEF SUMMARY

According to the present disclosure, an energy autonomous system includes a first capacitor that stores energy produced by an energy transducer, and provides the energy to a microprocessor that controls operation of the energy autonomous system. Accordingly, the energy autonomous system remains operational as long as the energy transducer produces energy. The microprocessor controls charging of a second capacitor (e.g., a supercapacitor) that provides energy to the microprocessor during periods of time when the energy transducer is not able to produce energy. Advantageously, the energy autonomous system does not include a PMIC because the microprocessor is used to control charging of the second capacitor, which lowers the cost of the energy autonomous system.

For example, the energy transducer includes a photovoltaic cell that produces energy so long as a sufficient amount of light illuminates the photovoltaic cell. Thus, the photovoltaic cell can typically supply energy to the first capacitor for operating the energy autonomous system during daytime, but is unable to supply energy to the first capacitor for operating the energy autonomous system during nighttime. The energy stored by second capacitor is supplied to the microprocessor during nighttime, to keep the energy autonomous system operational during nighttime.

Because systems according to the present disclosure are energy autonomous and require minimal or no maintenance, energy autonomous systems according to the present disclosure are suitable for use in so-called set and forget devices. Additionally, energy autonomous systems according to the present disclosure can be produced at a very low cost. Thus, energy autonomous systems according to the present disclosure are particularly well suited for Internet of Things (IoT) applications in which a very large number of systems is used.

A system according to the present disclosure may be characterized as including: an energy transducer; a first capacitor; a second capacitor having a capacitance that is greater than a capacitance of the first capacitor; and a microprocessor including: a first terminal electrically coupled to the energy transducer and the first capacitor; a second terminal electrically coupled to the second capacitor; a switch which, in operation, is in a conductive state in which the switch electrically couples the first terminal and the second terminal together, or a nonconductive state in which the switch does not electrically couple the first terminal and the second terminal together; a voltage detector which, in operation, detects a voltage at the first terminal, and a processor coupled to the voltage detector and the switch. The processor, in operation, controls charging of the second capacitor by controlling the switch to be in the conductive state and the nonconductive state based on the voltage at the first terminal detected by the voltage detector.

The processor may control the switch to be in the nonconductive state in response to the voltage detector detecting that the voltage at the first terminal is less than or equal to a first voltage threshold, and the processor may control the switch to be in the conductive state in response to the voltage detector detecting that the voltage at the first terminal is greater than or equal to a second voltage threshold that is greater than the first voltage threshold. The processor may control the switch to be in the conductive state in response to determining that a voltage of the second capacitor is greater than or equal to the first voltage threshold. The microprocessor may operates in a first power consumption mode in which the microprocessor consumes a first amount of power, and a second power consumption mode in which the microprocessor consumes a second amount of power that is greater than the first amount of power, and the processor may control the switch to be in the conductive state and causes the microprocessor to change from operating in the second power consumption mode to operating in the first power consumption mode in response to determining that a voltage of the second capacitor is greater than or equal to the first voltage threshold. The microprocessor, in operation, may charge the second capacitor in a discontinuous charging mode and continuous charging mode, in the discontinuous charging mode, the processor may control the switch to change from being in the conductive state to being in the nonconductive state, and change from being in the nonconductive state to being in the conductive state, and in the continuous charging mode, the processor may control the switch to be in the conductive state. The processor may control the microprocessor to operate in the first power consumption mode while the microprocessor charges the second capacitor in the continuous charging mode, and the processor may control the microprocessor to operate in the second power consumption mode while the microprocessor charges the second capacitor in the discontinuous charging mode. The processor, in operation, may cause the microprocessor to change from charging the second capacitor in the discontinuous charging mode to charging the second capacitor in the continuous charging mode in response to determining that the voltage of the second capacitor is greater than the first voltage threshold. The microprocessor may include a transmitter which, in operation, transmits a signal, the processor may cause the transmitter to transmit the signal while the microprocessor charges the second capacitor in the discontinuous charging mode, and the processor may not cause the transmitter to transmit the signal while the microprocessor charges the second capacitor in the continuous charging mode. The microprocessor may include a sensor which, in operation, provides an output to the processor, and the signal transmitted by the transmitter may be based on the output of the sensor.

A method according to the present disclosure may be characterized as including: coupling an energy transducer to a first terminal of a microprocessor; coupling a first capacitor to the first terminal of the microprocessor; coupling a second capacitor having a capacitance that is greater than a capacitance of the first capacitor to a second terminal of the microprocessor; detecting a voltage at the first terminal; and controlling charging of the second capacitor by controlling a switch included in the microprocessor to be a conductive state and a nonconductive state based on the voltage at the first terminal. In the conductive state, the switch electrically couples the first terminal and the second terminal together and, in the nonconductive state, the switch does not electrically couple the first terminal and the second terminal together.

The method may further include controlling the switch to be in the nonconductive state in response to the voltage at the first terminal being less than or equal to a first voltage threshold, and controlling the switch to be in the conductive state in response to the voltage at the first terminal being greater than or equal to a second voltage threshold that is greater than the first voltage threshold. The method may further include controlling the switch to be in the conductive state in response to determining that a voltage of the second capacitor is greater than or equal to the first voltage threshold. The microprocessor may operate in a first power consumption mode in which the microprocessor consumes a first amount of power, and a second power consumption mode in which the microprocessor consumes a second amount of power that is greater than the first amount of power, and the method may further include controlling the switch to change from being in the conductive state and controlling the microprocessor to change from operating in the second power consumption mode to operating in the first power consumption mode in response to determining that a voltage of the second capacitor is greater than or equal to the first voltage threshold. The method may further include charging the second capacitor in a discontinuous charging mode by controlling the switch to change from being in the conductive state to being in the nonconductive state, and change from being in the nonconductive state to being in the conductive state; and charging the second capacitor in a continuous charging mode by controlling the switch to be in the conductive state. The method may further include controlling the microprocessor to operate in the first power consumption mode while the microprocessor charges the second capacitor in the continuous charging mode, and controlling the microprocessor to operate in the second power consumption mode while the microprocessor charges the second capacitor in the discontinuous charging mode. The method may further include controlling the microprocessor to change from charging the second capacitor in the discontinuous charging mode to charging the second capacitor in the continuous charging mode in response to determining that the voltage of the second capacitor is greater than the first voltage threshold. The method may further include controlling a transmitter included in the microprocessor to transmit a signal while the microprocessor charges the second capacitor in the discontinuous charging mode, where the transmitter is not controlled to transmit the signal while the microprocessor charges the second capacitor in the continuous charging mode. The signal transmitted by the transmitter may be based on output of a sensor included in the microprocessor.

A system according to the present disclosure may be characterized as including: an energy transducer; a first capacitor; a battery; and a microprocessor including: a first terminal electrically coupled to the energy transducer and the first capacitor; a second terminal electrically coupled to the battery; a switch which, in operation, is in a conductive state in which the switch electrically couples the first terminal and the second terminal together, or a nonconductive state in which the switch does not electrically couple the first terminal and the second terminal together; a voltage detector which, in operation, detects a voltage at the first terminal, and a processor coupled to the voltage detector and the switch. The processor, in operation, controls charging of the battery by controlling the switch to be the conductive state and the nonconductive state based on the voltage at the first terminal detected by the voltage detector.

The processor may control the switch to be in the nonconductive state in response to the voltage detector detecting that the voltage at the first terminal is less than or equal to a first voltage threshold, and the processor may control the switch to be in the conductive state in response to the voltage detector detecting that the voltage at the first terminal is greater than or equal to a second voltage threshold that is greater than the first voltage threshold.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings:

FIG. 1 shows a block diagram of an energy autonomous system according to an embodiment of the present disclosure.

FIGS. 2A, 2B, 2C, and 2D show diagrams for explaining operation of the energy autonomous system shown in FIG. 1.

FIG. 3 shows another diagram for explaining operation of the energy autonomous system shown in FIG. 1.

FIG. 4 shows an example of switching between a discontinuous charging mode and a continuous charging mode for charging the second capacitor of the energy autonomous system shown in FIG. 1.

### DETAILED DESCRIPTION

A system according to an embodiment of the present disclosure implements a wireless sensor platform with a minimal bill of materials (BOM) (i.e., cost) and power consumption. The system uses a single Microcontroller Unit (MCU) to perform energy management, in addition to sensing, calculation, and radio transmission activities.

The system uses two capacitors to store the energy produced by an energy harvester. A first capacitor of small capacity (uF to mF) gives agility to the system and makes it ready to operate as soon as and for as long as an energy source can produce. A second capacitor, of high value, i.e., a supercapacitor (Farads), stores energy in periods in which a sensor is idle and at the same time the energy source can produce energy. The energy stored by the supercapacitor is used by the system as a backup to operate during periods when the energy source is unable to supply energy.

Embodiments according to the present disclosure include an energy transducer that is used to charge the first capacitor and the second capacitor. The energy transducer and/or the first capacitor provides energy to a microprocessor while the energy transducer produces energy, and the second capacitor provides energy to the microprocessor while the energy transducer does not produce energy. In one or more implementations, the first capacitor is a normal capacitor, and the second capacitor is a supercapacitor.

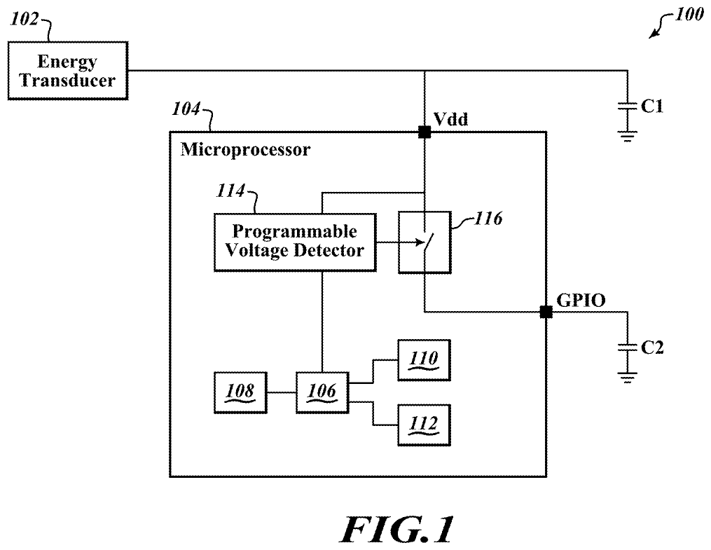

FIG. 1 shows a block diagram of an energy autonomous system 100 according to an embodiment of the present disclosure. The energy autonomous system 100 includes an energy transducer 102, a microprocessor 104, a first capacitor C1, and a second capacitor C2.

In one or more implementations, the energy transducer 102 includes a photovoltaic cell or panel. Table 1 shows examples of different photovoltaic cells available from Panasonic Battery that can be used as the energy transducer 102. Other types of energy transducers (e.g., piezoelectric transducers, thermocouples, wind turbines, etc.) may be used as the energy transducer 102 within the scope of the present disclosure.

TABLE 1

| Light | | | Charging |
|---|---|---|---|
| Intensity | | Charging Rate | Time from |
| [Lux]v | Photovoltaic Panel | [mV/minute] | 0 V to 1V |
| 4000 | Panasonic AM-1606C | 6 | 2 h-43 min |
| | (15 mm × 15 mm) | | |
| | Panasonic AM-1815CA | 58 | 18 min |
| | (58.1 mm × 48.6 mm) | | |
| 12000 | Panasonic AM-1606C | 23 | 44 min |
| | Panasonic AM-1815CA | 99 | 11 min |
| 25000 | Panasonic AM-1606C | 70 | 15 min |
| | Panasonic AM-1815CA | 140 | 8 min |

In one or more implementations, the microprocessor 104 is a model STM32WL5x microcontroller unit (MCU) available from STMicroelectronics. Other microprocessors may be used as the microprocessor 104 within the scope of the present disclosure.

The microprocessor 104 includes a processor 106 and a memory 108 that stores instructions which, when executed by the processor 106, cause the microprocessor 104 to perform the functions described herein. The microprocessor 104 also includes a sensor 110, for example, a temperature sensor, a light sensor, a humidity sensor, etc. In addition, the microprocessor 104 includes communication circuitry 112, which may include a transmitter and a receiver that transmit and receive signals according to the one or more communication standards, for example, in the Bluetooth or IEEE 802.11 family of communication standards. For example, the sensor 110 periodically measures a temperature and provides a corresponding output, and a transmitter included in the communication circuitry 112 periodically transmits a signal including data that is based on the output of the sensor 110.

In addition, the microprocessor 104 includes a number of terminals for connecting to external devices. For illustrative simplicity, only two of the terminals of the microprocessor 104 are shown in FIG. 1. More particularly, the microprocessor 104 includes a terminal Vdd to which a power supply voltage is provided in order to power the microprocessor 104 so that it can operate. In addition, the microprocessor 104 includes a general-purpose input/output (GPIO) interface, which includes a terminal GPIO.

The microprocessor 104 also includes a voltage detector 114 coupled to the terminal Vdd and the processor 106. In one or more implementations, the voltage detector 114 is a programmable voltage detector (PVD).

For example, the voltage detector 114 includes a comparator having a power terminal, a non-inverting input terminal, and an inverting input terminal. The power terminal of the comparator is coupled to the terminal Vdd, which supplies power to the comparator that enables it to operate. The voltage detector 114 also includes a resistor having a first terminal coupled to the terminal Vdd of the microprocessor 104, and a second terminal coupled to the non-inverting input terminal of the comparator. Additionally, the voltage detector 114 includes a variable resistor having a first terminal coupled to the non-inverting input terminal of the comparator, and a second terminal that is grounded. In addition, the voltage detector 114 includes a reference voltage source that provides a reference voltage to the inverting input terminal of the comparator. The processor 106 controls the resistance of the variable resistor and/or a magnitude of the reference voltage in order to set different threshold voltage levels of the voltage detector 114. If the voltage at the terminal Vdd is greater than a particular threshold voltage level set by the processor 106, the voltage detector 114 outputs a signal to the processor 106, which controls a switch 116 based on the output of the voltage detector 114.

The switch 116 has a terminal electrically coupled to the terminal Vdd, and a terminal electrically coupled to the terminal GPIO. Depending on a characteristic (e.g., voltage level) of a control signal provided by the processor 106 to the switch 116, the switch 116 is in either a conductive or a nonconductive state. While the switch 116 is in the conductive state, the switch 116 electrically couples the terminal Vdd and the terminal GPIO to each other. While the switch 116 is in the nonconductive state, the switch 116 does not electrically couple the terminal Vdd and the terminal GPIO to each other.

The processor 106 also sets a power consumption mode of the microprocessor 104 based on the output of the voltage detector 114. The microprocessor 104 operates in a first power consumption mode (e.g., sleep mode or stop mode) in which the microprocessor 104 consumes a first amount of power, and a second power consumption mode (e.g., normal mode or run mode) in which the microprocessor 104 consumes a second amount of power that is greater than the first amount of power. For example, the processor 106 outputs a signal having a particular characteristic (e.g., voltage level) or changes a value stored in a register to set the power consumption mode of the microprocessor 104.

The processor 106 causes the microprocessor 104 to change to operating in the first power consumption mode in response to the voltage detector 114 detecting that the voltage at the terminal Vdd is less than or equal to a first voltage threshold (e.g., 2 V) while the microprocessor 104 operates in the second power consumption mode. Also, the processor 106 causes the microprocessor 104 to change to operating in the second power consumption mode in response to the voltage detector 114 detecting that the voltage at the terminal Vdd is greater than or equal to the first voltage threshold while the microprocessor 104 operates in the first power consumption mode.

As mentioned above, the energy autonomous system 100 include the first capacitor C1 and the second capacitor C2. The first capacitor C1 is an ordinary capacitor, which also may be referred to as a single-layer capacitor, because it forms a single layer of charge between two plates. The first capacitor C1 includes a first terminal that is electrically coupled to the terminal Vdd of the microprocessor 104, and a second terminal the is electrically coupled to a reference potential, such as a ground potential. In one or more implementations, the first capacitor C1 has a capacitance of 470 microfarads (μF). In one or more implementations, the energy autonomous system 100 includes two first capacitors C1 arranged in parallel, wherein each of the capacitors C1 has a capacitance of 470 μF.

The second capacitor C2 is a supercapacitor, which also may be referred to as an ultracapacitor or a double-layer capacitor, which can store more energy than an ordinary capacitor by creating a double layer of charge between two plates. The second capacitor C2 includes a first terminal that is electrically coupled to the terminal GPIO of the microprocessor 104, and a second terminal the is electrically coupled to a reference potential, such as a ground potential. In one or more implementations, the second capacitor C2 has a capacitance of at least 1 Farad (F). Thus, the capacitance of the second capacitor C2 is much greater that the capacitance of the first capacitor C1.

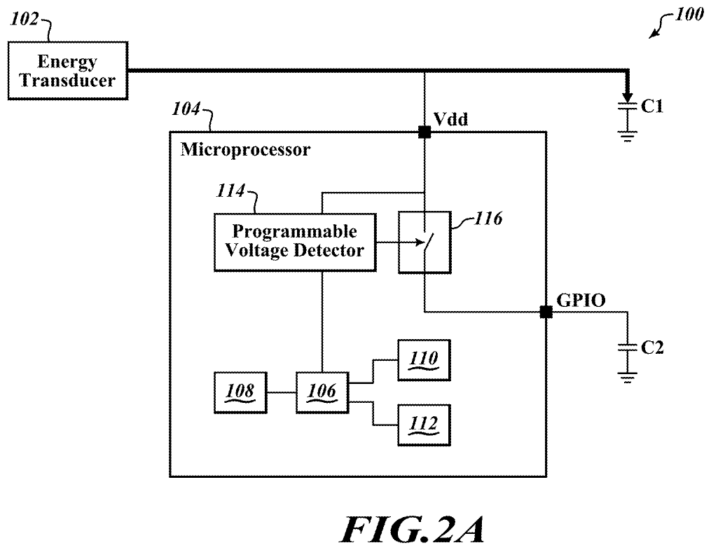

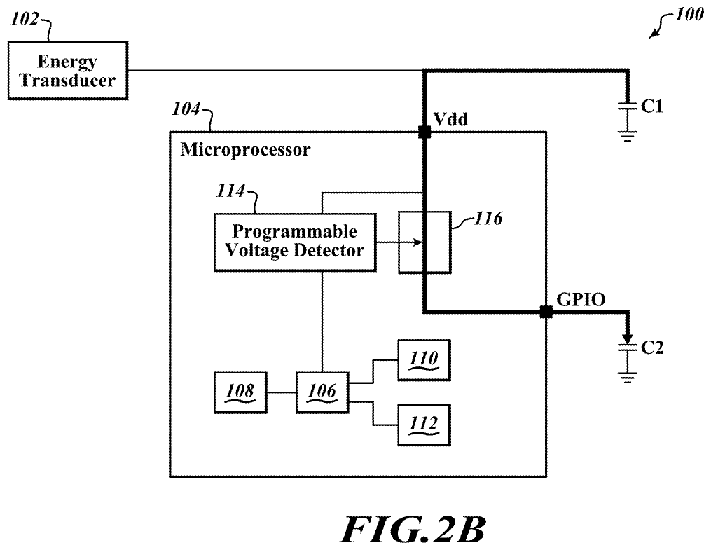

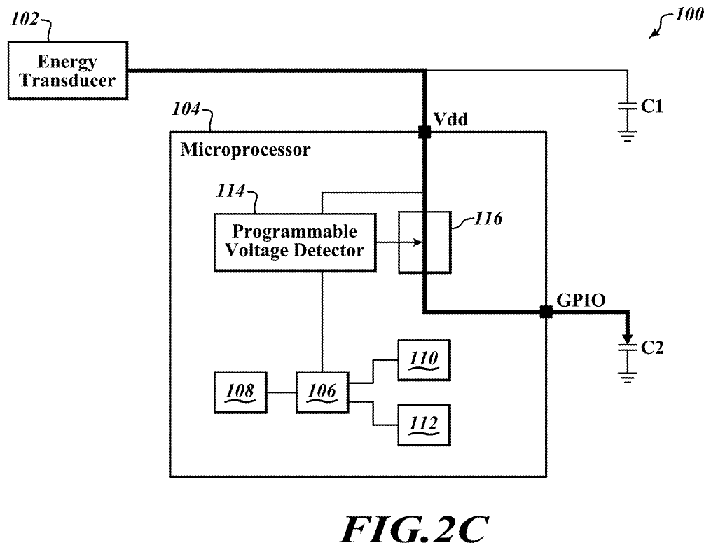

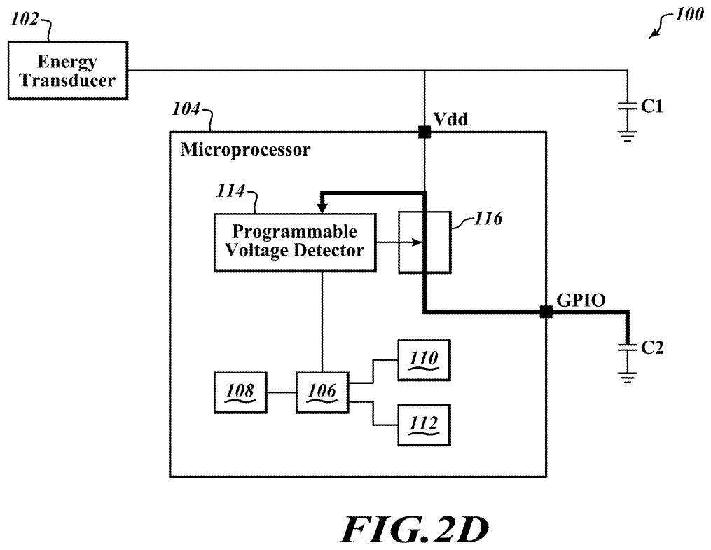

FIGS. 2A, 2B, 2C, and 2D show diagrams for explaining operation of the energy autonomous system 100. FIG. 2A shows the energy autonomous system 100 operating in an energy harvesting mode, for example, when the energy autonomous system 100 is initially deployed. Assume that the first capacitor C1 is initially discharged and the energy transducer 102 is outputting energy. For example, the energy transducer 102 is a photovoltaic cell that is being illuminated by the sun. Energy output by the energy transducer 102 is provided to the terminal Vdd of the microprocessor 104 and to the first capacitor C1. Accordingly, the first capacitor C1 charges and the microprocessor 104 is able to operate.

FIG. 2B shows the energy autonomous system 100 operating in a discontinuous charging mode, which may follow operation of the energy autonomous system 100 in the energy harvesting mode. The energy autonomous system 100 transitions from the energy harvesting mode to the discontinuous charging mode in response to the microprocessor 104 determining that the first capacitor C1 is sufficiently charged such that it can charge the second capacitor C2.

For example, the processor 106 determines whether the voltage at the terminal Vdd is greater than or equal to a second voltage threshold (e.g., 3 V) based on output from the voltage detector 114. In response to determining that the voltage at the terminal Vdd is greater than or equal to the second voltage threshold, the processor 106 provides a control signal to the switch 116 that causes the switch 116 to be in the conductive state. Accordingly, a current flows from the first capacitor C1 through the terminal Vdd, the switch 116, and the terminal GPIO to the second capacitor C2, which causes the second capacitor C2 to charge.

FIG. 2C shows the energy autonomous system 100 operating in a continuous charging mode, which follows operation of the energy autonomous system 100 in the discontinuous charging mode. Before entering the continuous charging mode, the microprocessor 104 determines that second capacitor C2 is sufficiently charged such that it will not cause the microprocessor 104 reset. For example, the microprocessor 104 requires at least 1.7 volts (V) to be applied to the terminal Vdd in order for the microprocessor 104 to operate. If a voltage of less than 1.7 V is applied to the terminal Vdd while the microprocessor 104 is operating, the microprocessor 104 stops operating and resets. The first voltage threshold (e.g., 1.8 V or 2.0 V) can be established to ensure that the microprocessor 104 does not reset. In addition, the processor 106 causes the microprocessor 104 to operate in the first power consumption mode (e.g., sleep mode or stop mode) while the energy autonomous system 100 operates in the continuous charging mode.

The memory 108 stores instructions that cause the processor 106 to determine or estimate the amount of charge in the second capacitor C2 based on the amount of time that the energy transducer 102 and/or the first capacitor C1 charges the second capacitor C2 while the energy autonomous system 100 operates in the discontinuous charging mode shown in FIG. 2B. For example, the processor 106 determines or estimates the amount of charge in the second capacitor C2 based on timers set by the processor 106, characteristics of the energy transducer 102 (e.g., see Table 1), and the particular capacitance of the second capacitor C2. After the processor 106 determines that the second capacitor C2 has been sufficiently charged from operating in the discontinuous charging mode, the processor 106 provides a control signal to the switch 116 that causes the switch 116 to be in the conductive state. Accordingly, a current flows from the energy transducer 102 through the terminal Vdd, the switch 116, and the terminal GPIO to the second capacitor C2, which causes the second capacitor C2 to charge.

The capacitor C2 is charged much more efficiently in the continuous charging mode shown in FIG. 2C while the microprocessor 104 operates in the first power consumption mode (e.g., sleep mode or stop mode), than in the discontinuous charging mode shown in FIG. 2B while the microprocessor 104 operates in the second power consumption mode (e.g., normal mode or run mode). For example, if the energy transducer 102 is a photovoltaic cell that is illuminated with a light intensity of 2600 Lux, and the capacitor C2 has a capacitance of 1 F, 0.206 Joules per minute are provided to the capacitor C2 in the continuous charging mode, while only 0.022 Joules per minute are provided to the capacitor C2 in the discontinuous charging mode.

FIG. 2D shows the energy autonomous system 100 operating in a secondary power source mode, which follows operation of the energy autonomous system 100 in the discontinuous charging mode and the continuous charging mode. The microprocessor 104 determines or estimates the amount of charge stored in the second capacitor C2 based on the amount of time that the first capacitor C1 and/or the energy transducer 102 charges the second capacitor C2 while the energy autonomous system 100 operates in the discontinuous charging mode and the amount of time that the energy transducer 102 charges the second capacitor C2 while the energy autonomous system 100 operates in the continuous charging mode, based on characteristics of the energy transducer 102, the first capacitor C1, and the second capacitor C2, as discussed above. Also, the microprocessor 104 determines that the energy transducer 102 has stopped outputting energy for at least a predetermined amount of time, based on the voltage detected by the programmable voltage detector 114. After the microprocessor 104 determines that the second capacitor C2 is sufficiently charged and the energy transducer 102 has stopped outputting energy for at least the predetermined amount of time, the microprocessor 104 provides a control signal to the switch 116 that causes the switch 116 to be in the conductive state. Accordingly, a current flows from the second capacitor C2 through the terminal GPIO and the switch 116 to the terminal Vdd, which enables the microprocessor 104 to operate while the energy transducer 102 is not outputting energy. For example, if the energy transducer 102 is a photovoltaic cell, the processor 106 causes the energy autonomous system 100 to operate in the secondary power source mode shown in FIG. 2D during nighttime.

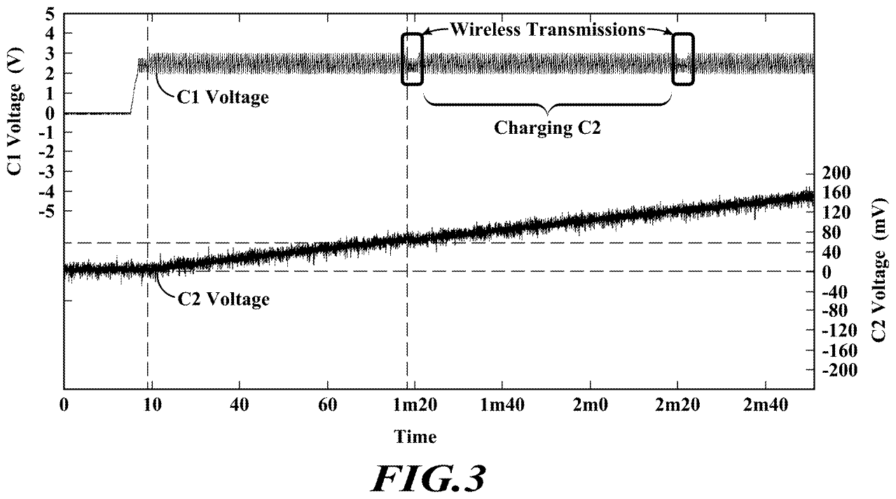

FIG. 3 shows another diagram for explaining operation of the energy autonomous system 100. FIG. 3 shows the voltage of the first capacitor C1 and the second capacitor C2 over time. Initially, the voltage of the first capacitor C1 is zero and the energy autonomous system 100 operates in the energy harvesting mode shown in FIG. 2A. After the voltage of the first capacitor C1 reaches the first voltage threshold (e.g., 2 V), the microprocessor 104 begins operating in the second power consumption mode. After the voltage of the first capacitor C1 reaches the second voltage threshold (e.g., 3 V), the autonomous system 100 begins operating in the discontinuous charging mode shown in FIG. 2B, and the voltage of the second capacitor C2 begins to increase.

While the energy autonomous system 100 operates in the second power consumption mode (e.g., normal mode or run mode), the microprocessor 104 periodically performs sensing functions using the sensor 110 (e.g., temperature sensor), and stores results of the sensing in the memory 108. The microprocessor 104 wirelessly transmits data based on the results of the sensing periodically using the communication circuitry 112, which results in a reduction of the voltage stored by the first capacitor C1.

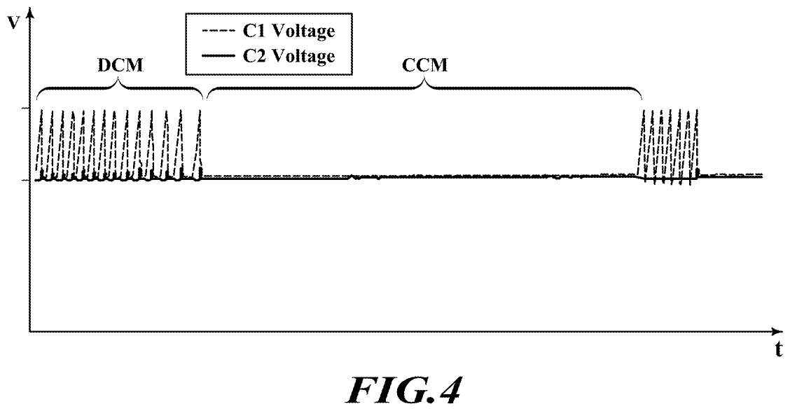

FIG. 4 shows an example of switching between the discontinuous charging mode (DCM) and the continuous charging mode (CCM) for charging the supercapacitor C2 shown in FIG. 1. While operating in the discontinuous charging mode (DCM), the voltage of the first capacitor C1 varies between the first voltage threshold (e.g., 2 V) and the second voltage threshold (e.g., 3 V). In response to the processor 106 determining that the voltage of the first capacitor C1 has reached the second voltage threshold, based on output from the programmable voltage detector 114, the processor 106 causes the microprocessor 104 to transmits sensor data using the communication circuitry 112 (e.g., Bluetooth transmitter), which results in the voltage of the first capacitor C1 decreasing. Also, the processor 106 output a control signal that causes the switch 116 to be in the conductive state so that the microprocessor 104 charges the second capacitor C2 using a current provided by the first capacitor C1 for a relatively brief period of time, as shown in FIG. 2B. When the processor 106 determines that the voltage of the first capacitor C1 has reached the first voltage threshold, based on output from the programmable voltage detector 114, the processor 106 causes the microprocessor 104 to operate in the first power consumption mode (e.g., sleep mode or stop mode) and

After a predetermined number of transmissions (e.g., 14) or a predetermined amount of time (e.g., 40 seconds), the processor 106 determines whether the voltage of the second capacitor C2 is greater than the first voltage threshold. After determining that the voltage of the second capacitor C2 is greater than the first voltage threshold, the processor 106 outputs a control signal that causes the switch 116 to be conductive state and then causes the microprocessor 104 to operate in the first power consumption mode (e.g., sleep mode or stop mode), which results in the second capacitor C2 being charged in the continuous charging mode (CCM).

After a predetermined amount of time (e.g., 2 minutes), if the voltage at the terminal Vdd is greater than the first voltage threshold, the processor 106 causes the microprocessor 104 to operate in the second power consumption mode (e.g., normal mode or run mode), and causes the switch 116 to be in the nonconductive state, which results in the second capacitor C2 being charged in the discontinuous charging mode (DCM). For example, the predetermined amount of time corresponds to a time that the microprocessor 104 is scheduled to perform a sensing operation using the sensor 110 and/or transmit data using the communication circuitry 112.

Accordingly, the energy autonomous system 100 periodically switches between charging the second capacitor C2 in the discontinuous charging mode (DCM) and charging the second capacitor C2 in the continuous charging mode (CCM). This causes the second capacitor C2 to store a sufficient amount of charge that enables the second capacitor C2 to power the microprocessor 104 in the secondary power source mode shown in FIG. 2D while the energy transducer 102 is not able to output energy, for example, during nighttime.

In one or more implementations, the microprocessor 104 increases the first voltage threshold (e.g., from 2 V to 2.3 V) while charging the second capacitor C2 in the discontinuous charging mode, which increases the amount of time that the second capacitor C2 is charged in the discontinuous charging mode.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. For example, a rechargeable battery may be used instead of the second capacitor C2.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
an energy transducer;
a first capacitor;
a second capacitor, wherein a capacitance of the second capacitor is greater than a capacitance of the first capacitor; and
a microprocessor including:
a first terminal electrically coupled to the energy transducer and the first capacitor;
a second terminal electrically coupled to the second capacitor;
a switch which, in operation, is in a conductive state in which the switch electrically couples the first terminal and the second terminal together, or a nonconductive state in which the switch does not electrically couple the first terminal and the second terminal together;
a voltage detector which, in operation, detects a voltage at the first terminal, and
a processor coupled to the voltage detector and the switch,
wherein the processor, in operation, controls charging of the second capacitor by controlling the switch to be in the conductive state and the nonconductive state based on the voltage at the first terminal detected by the voltage detector.

2. The system according to claim 1 wherein:
the processor controls the switch to be in the nonconductive state in response to the voltage detector detecting that the voltage at the first terminal is less than or equal to a first voltage threshold, and
the processor controls the switch to be in the conductive state in response to the voltage detector detecting that the voltage at the first terminal is greater than or equal to a second voltage threshold that is greater than the first voltage threshold.

3. The system according to claim 2 wherein the processor controls the switch to be in the conductive state in response to determining that a voltage of the second capacitor is greater than or equal to the first voltage threshold.

4. The system according to claim 2 wherein:
the microprocessor operates in a first power consumption mode in which the microprocessor consumes a first amount of power, and a second power consumption mode in which the microprocessor consumes a second amount of power that is greater than the first amount of power, and
the processor controls the switch to be in the conductive state and causes the microprocessor to change from operating in the second power consumption mode to operating in the first power consumption mode in response to determining that a voltage of the second capacitor is greater than or equal to the first voltage threshold.

5. The system according to claim 4 wherein:
the microprocessor, in operation, charges the second capacitor in a discontinuous charging mode and continuous charging mode,
in the discontinuous charging mode, the processor controls the switch to change from being in the conductive state to being in the nonconductive state, and change from being in the nonconductive state to being in the conductive state, and
in the continuous charging mode, the processor controls the switch to be in the conductive state.

6. The system according to claim 5 wherein:
the processor controls the microprocessor to operate in the first power consumption mode while the microprocessor charges the second capacitor in the continuous charging mode, and
the processor controls the microprocessor to operate in the second power consumption mode while the microprocessor charges the second capacitor in the discontinuous charging mode.

7. The system according to claim 5 wherein the processor, in operation, causes the microprocessor to change from charging the second capacitor in the discontinuous charging mode to charging the second capacitor in the continuous charging mode in response to determining that the voltage of the second capacitor is greater than the first voltage threshold.

8. The system according to claim 5 wherein:
the microprocessor includes a transmitter which, in operation, transmits a signal,
the processor causes the transmitter to transmit the signal while the microprocessor charges the second capacitor in the discontinuous charging mode, and
the processor does not cause the transmitter to transmit the signal while the microprocessor charges the second capacitor in the continuous charging mode.

9. The system according to claim 8 wherein:
the microprocessor includes a sensor which, in operation, provides an output to the processor, and
the signal transmitted by the transmitter is based on the output of the sensor.

10. A method, comprising:
coupling an energy transducer to a first terminal of a microprocessor;
coupling a first capacitor to the first terminal of the microprocessor;
coupling a second capacitor to a second terminal of the microprocessor, wherein a capacitance of the second capacitor is greater than a capacitance of the first capacitor;
detecting a voltage at the first terminal; and
controlling charging of the second capacitor by controlling a switch included in the microprocessor to be a conductive state and a nonconductive state based on the voltage at the first terminal,
wherein, in the conductive state, the switch electrically couples the first terminal and the second terminal together, and
wherein, in the nonconductive state, the switch does not electrically couple the first terminal and the second terminal together.

11. The method according to claim 10, further comprising:
controlling the switch to be in the nonconductive state in response to the voltage at the first terminal being less than or equal to a first voltage threshold, and
controlling the switch to be in the conductive state in response to the voltage at the first terminal being greater than or equal to a second voltage threshold that is greater than the first voltage threshold.

12. The method according to claim 11, further comprising:
controlling the switch to be in the conductive state in response to determining that a voltage of the second capacitor is greater than or equal to the first voltage threshold.

13. The method according to claim 11 wherein:
the microprocessor operates in a first power consumption mode in which the microprocessor consumes a first amount of power, and a second power consumption mode in which the microprocessor consumes a second amount of power that is greater than the first amount of power, and
the method further comprises controlling the switch to change from being in the conductive state and controlling the microprocessor to change from operating in the second power consumption mode to operating in the first power consumption mode in response to determining that a voltage of the second capacitor is greater than or equal to the first voltage threshold.

14. The method according to claim 13, further comprising:
charging the second capacitor in a discontinuous charging mode by controlling the switch to change from being in the conductive state to being in the nonconductive state, and change from being in the nonconductive state to being in the conductive state; and
charging the second capacitor in a continuous charging mode by controlling the switch to be in the conductive state.

15. The method according to claim 14, further comprising:
controlling the microprocessor to operate in the first power consumption mode while the microprocessor charges the second capacitor in the continuous charging mode, and
controlling the microprocessor to operate in the second power consumption mode while the microprocessor charges the second capacitor in the discontinuous charging mode.

16. The method according to claim 15, further comprising:
controlling the microprocessor to change from charging the second capacitor in the discontinuous charging mode to charging the second capacitor in the continuous charging mode in response to determining that the voltage of the second capacitor is greater than the first voltage threshold.

17. The method according to claim 14, further comprising:
controlling a transmitter included in the microprocessor to transmit a signal while the microprocessor charges the second capacitor in the discontinuous charging mode,
wherein the transmitter is not controlled to transmit the signal while the microprocessor charges the second capacitor in the continuous charging mode.

18. The method according to claim 17 wherein the signal transmitted by the transmitter is based on output of a sensor included in the microprocessor.

19. A system, comprising:
an energy transducer;
a first capacitor;
a battery; and
a microprocessor including:
a first terminal electrically coupled to the energy transducer and the first capacitor;
a second terminal electrically coupled to the battery;
a switch which, in operation, is in a conductive state in which the switch electrically couples the first terminal and the second terminal together, or a nonconductive state in which the switch does not electrically couple the first terminal and the second terminal together;
a voltage detector which, in operation, detects a voltage at the first terminal, and
a processor coupled to the voltage detector and the switch,
wherein the processor, in operation, controls charging of the battery by controlling the switch to be the conductive state and the nonconductive state based on the voltage at the first terminal detected by the voltage detector.

20. The system according to claim 19 wherein:
the processor controls the switch to be in the nonconductive state in response to the voltage detector detecting that the voltage at the first terminal is less than or equal to a first voltage threshold, and
the processor controls the switch to be in the conductive state in response to the voltage detector detecting that the voltage at the first terminal is greater than or equal to a second voltage threshold that is greater than the first voltage threshold.
